(19) United States
(12) Patent Application Publication
(10) Pub. No.: US 2010/0254285 A1
(43) Pub. Date: Oct. 7, 2010

(54) INFORMATION COMMUNICATION TERMINAL

(75) Inventor: Hideo Okano, Hanno-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: OLYMPUS CORPORATION, Tokyo (JP)

(21) Appl. No.: 12/754,263

(22) Filed: Apr. 5, 2010

(30) Foreign Application Priority Data
Apr. 6, 2009 (JP) 2009-092339

(51) Int. Cl. H04L 12/28

(52) U.S. Cl. 370/254

(57) ABSTRACT

A receiver is configured to receive a wireless connection request from a predetermined external terminal. A wireless connection information generator is configured to generate wireless connection setting information, based on the wireless connection request. A storage is configured to store the generated wireless connection setting information. A transmitter is configured to transmit the generated wireless connection setting information to the predetermined external terminal. A connector is configured to make wireless connection to the predetermined external terminal, based on the wireless connection setting information. A detector is configured to determine whether a communication state of the predetermined external terminal confirms to one of predetermined conditions. A wireless connection setting information update unit is configured to nullify, erase or update a part or all of the wireless connection setting information stored in the storage, when a communication state of the predetermined external terminal conforms to one of the predetermined conditions.

### CROSS-REFERENCE TO RELATED APPLICATIONS

This application is based upon and claims the benefit of priority from prior Japanese Patent Application No. 2009-092339, filed Apr. 6, 2009, the entire contents of which are incorporated herein by reference.

### BACKGROUND OF THE INVENTION

1. Field of the Invention

The present invention relates to an information communication terminal such as a personal computer and kiosk terminal, which makes communication with a predetermined external terminal such as a digital camera, cell-phone and PDA through wireless connection.

2. Description of the Related Art

An image taken by a digital camera is transmitted to a personal computer (a PC) by wired or wireless communication, and processed by the PC, or stored in a database for later access and use.

If one personal computer is shared by two or more persons and security of data is insufficient, data may be used or stolen by other persons. Particularly, pictorial data directly concerns privacy of a photographer. Therefore, pictorial data is a kind of data, which is not to be transferred and shown to or used by persons not admitted by a photographer.

Jpn. Pat. Apln. KOKAI Publication No. 11-252504 proposes an authentication system, which makes data protection by authentication by a digital camera used to take a picture, when a picture taken by a digital camera is used in a personal computer.

Recently, an information communication terminal (a kiosk terminal) such as a photoprint service has been used as a device to output an image taken by a digital camera or a camera cell-phone. By using a kiosk terminal, such an image can be printed as a photo away from home.

Security must be ensured even in wireless communication between a digital camera and an information communication terminal such as a personal computer and a kiosk terminal.

Wireless fidelity (Wi-Fi) protected setup (WPS) used in a computer system or a communication system is known as a method of using a local area network (LAN) with ensured security. In WPS, security of an extended service set identifier (ESSID) and a cipher system of Wi-Fi protected access 2 (WPA 2) is automatically set by pressing buttons provided at an access point and in a device used.

By using WPS, connection and security setting can be easily established in wireless communication between a digital camera and an information communication terminal such as a personal computer and a kiosk terminal.

### BRIEF SUMMARY OF THE INVENTION

According to an aspect of the present invention, there is provided an information communication terminal for making communication with a predetermined external terminal through wireless connection, comprising:

a receiver configured to receive a wireless connection request from the predetermined external terminal;

a wireless connection information generator configured to generate wireless connection setting information, based on the wireless connection request;

a storage configured to store the wireless connection setting information generated by the wireless connection information generator;

a transmitter configured to transmit the wireless connection setting information generated by the wireless connection information generator, to the predetermined external terminal;

a connector configured to make wireless connection to the predetermined external terminal, based on the wireless connection setting information;

a detector configured to determine whether a communication state of the predetermined external terminal confirms to one of predetermined conditions; and

a wireless connection setting information update unit configured to perform one of nullification, erasion and update of one of a part and all of the wireless connection setting information stored in the storage, when a communication state of the predetermined external terminal conforms to one of the predetermined conditions.

Advantages of the invention will be set forth in the description which follows, and in part will be obvious from the description, or may be learned by practice of the invention. Advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a diagram illustrating a configuration of an information processing system, in which an information communication terminal according to an embodiment of the invention is used;

FIG. 2 is a diagram showing a detailed configuration of the information processing system;

FIG. 3 is a flowchart of automatic wireless communication setting in a digital camera as an external terminal and a kiosk terminal as an information communication terminal according to an embodiment of the invention;

FIG. 4 is a flowchart of automatic wireless communication procedure in a digital camera and a kiosk terminal; and

FIG. 5 is a flowchart for explaining another example of wireless communication procedure in a digital camera and a kiosk terminal.

### DETAILED DESCRIPTION OF THE INVENTION

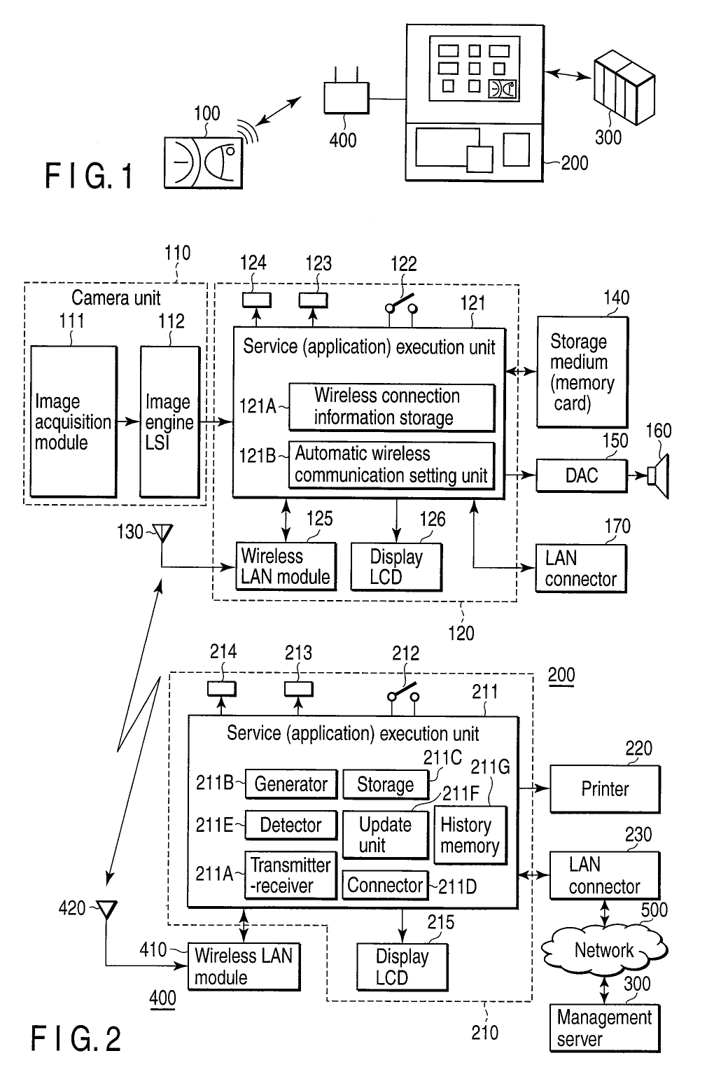

As shown in FIG. 1, an information processing system using an information communication terminal according to an embodiment of the invention includes a digital camera 100, a kiosk terminal 200, and a management server 300. In the information processing system, even the kiosk terminal 200 not having a wireless communication function can have an access point 400 to enable wireless communication with the digital camera 100.

The digital camera 100 is an external terminal. The digital camera 100 has a wireless communication function, and is provided with a built-in storage medium for recording a photographic image. The kiosk terminal 200 is an information communication terminal according to an embodiment of the invention, to which the digital camera 100 is connected. The kiosk terminal 200 has a function of making wireless communication with the digital camera 100 directly or through the access point 400, and a function of displaying a photographic image recorded in the storage medium of the digital camera 100. The kiosk terminal 200 has a function of inquiring the management server 300 about various information through a network. The kiosk terminal 200 is installed in a store in each place. In FIG. 1, only one kiosk terminal is shown to simplify the drawing. The management server 300 has functions of managing accounts and contents, temporarily storing photographic images, and printing photos. The management server 300 is controlled by the kiosk terminal 200 through the network.

As shown in FIG. 2, the digital camera 100 includes a camera unit 110, an information terminal unit 120, an antenna 130, a storage medium 140, a digital-analog converter (DAC) 150, a speaker 160, and a LAN connector 170.

The camera unit 110 includes an image acquisition module 111, and an image engine LSI 112. The image acquisition module 111 includes an imaging lens, and an image sensor, which are not shown in the drawing. The image engine LSI 112 performs gamma correction and white balance adjustment for an image signal obtained from the image acquisition module 111, or compresses an image.

The information terminal unit 120 includes a service (application) execution unit 121, and an operating part 122, an LED 123, an IrDA 124, a wireless LAN module 125, and a display LCD 126, which are connected to the service execution unit 121. The service execution unit 121 includes a CPU, and a memory, which are not shown in the drawing. The service execution unit 121 executes one or more service (application), and controls the functions of the information terminal unit 120. The service execution unit 121 is configured to realize the functions of the information terminal unit 120 by sequentially processing an information-processing program stored in a CPU or an external nonvolatile memory. The service execution unit 121 includes a wireless connection information storage 121A, and an automatic wireless communication setting unit 121B.

The wireless connection information storage 121A stores wireless connection setting information for making wireless connection to the kiosk terminal 200.

The automatic wireless communication setting unit 121B sets wireless connection to the kiosk terminal 200 based on the wireless connection setting information stored in the wireless connection information storage 121A.

The operating part 122 is a member such as a shutter button or cursor keys operated by a user. The LED 123 is a light-emitting part for notifying the user of states of the digital camera 100. The IrDA 124 is an infrared-emitting part for transmitting information to an external device by infrared rays. The wireless LAN module 125 performs wireless communication with the kiosk terminal 200 by using the antenna 130. The display LCD 126 displays a photographic image taken by the camera unit 110, or displays menu and various information depending on states of the operating part 122.

The storage medium 140 is a memory card, etc. for saving a photographic image taken by the camera unit 110. The storage medium may be built in and nonremovable from the digital camera 100, or may be removable from the digital camera 100.

The DAC 150 converts a message for notifying the user of the states of the digital camera 100 occurred in the service execution unit 121, into an analog audio signal. The speaker 160 produces a sound of the analog audio signal.

The LAN connector 170 is used for wired connection to a network such as Internet through a cable.

As shown in FIG. 2, the kiosk terminal 200 includes an information terminal unit 210, a printer 220, and a LAN connector 230.

The information terminal unit 210 includes a service (application) execution unit 211, and an operating part 212, an LED 213, an IrDA receiver 214, and a display LCD, which are connected to the service execution unit 211. The service execution unit 211 includes a CPU and a memory, which are not shown in the drawing. The service execution unit 211 executes one or more service (application), and controls the functions of the information terminal unit 210. The service execution unit 211 is configured to realize the functions of the information terminal unit 210, by sequentially processing an information-processing program stored in a CPU or an external nonvolatile memory. The service execution unit 211 includes a transmitter-receiver 211A, a generator 211B, a storage 211C, a connector 211D, a detector 211E, an update unit 211F, and a history memory 211G.

The transmitter-receiver 211A functions as a receiver to receive a wireless connection request from the digital camera 100 that is the predetermined external terminal, and as a transmitter to transmit wireless connection setting information to the digital camera 100. The generator 211B functions as a wireless connection information generator to generate the wireless connection setting information based on the wireless connection request. The storage 211C has a function of storing the wireless connecting setting information generated by the generator 211B. The connector 211D functions as a connector to make wireless connection to the digital camera 100 based in the wireless connecting setting information. The detector 211E has a function of determining whether a communication state of the digital camera 100 conforms to predetermined conditions. The update unit 211F functions as a wireless connection setting information update unit to nullify, erase and/or update a part or all of the wireless connection setting information stored in the storage 211C, when a communication state of the digital camera 100 conforms to the predetermined conditions. The history memory 211G has a function of storing at least a part of current wireless connection setting information, before the wireless connection setting information is nullified, erased and/or updated by the update unit 211F.

The operating part 212 is a member such as a button operated by the user. The LED 213 is a light-emitting part for notifying the user of the states of the kiosk terminal 200. The IrDA receiver 214 is an infrared-receiving part for receiving information from an external device by infrared rays. The display LCD 215 displays a photographic image received from the digital camera 100, or displays menu and various information depending on states of the operating part 212. If the operating part 212 is configured as a touch key on the display LCD 215, the same effect as that obtained by providing multiple buttons can be obtained without increasing the number of button members.

The printer 220 prints a photographic image received from the digital camera 100. In some cases, the kiosk terminal 200 may not be provided with the printer 220.

The LAN connector 230 is used for wired connection to a network such as Internet 500 through a cable. The LAN connector 230 enables the kiosk terminal 200 to communicate with the management server 300 through a network.

The access point 400 includes a wireless LAN module 410, and an antenna 420, as shown in FIG. 2. The wireless LAN module 410 is used for wired connection to the kiosk terminal 200, and makes wireless communication between the digital camera 100 and kiosk terminal 200 by using the antenna 420.

Next, an explanation will be given of the operation of the information processing system configured as described above.

Before starting communication between the digital camera 100 and kiosk terminal 200 through a wireless LAN, the digital camera 100 and/or kiosk terminal 200 are set to initial states necessary for making communication. Thereafter, the digital camera 100 can start communication with the kiosk terminal 200, thereby decreasing the processing amount in the kiosk terminal 200 for starting communication.

In prior art, the digital camera 100 and kiosk terminal 200 are connected through a universal serial bus (BUS) cable, and simply initialized by exchanging network setting information. Then, the digital camera 100 is turned on, and communication is started.

To make the initial setting by radio, a wireless LAN device is connected and security is set, which are called Wi-Fi protected setup (WPS). The LAN related industry group “Wi-Fi Alliance” defines the specifications of WPS, and authorizes application equipment since January, 2007.

WPS provides a scheme to register the digital camera 100 as a client (a slave unit) in a wireless LAN. A device used for registering the digital camera 100 as a client is called a registrar. A scheme prepared in WPS is a pushbutton system, or a personal identification (PIN) number code system.

In a pushbutton system, security setting of an extended service set identifier (ESSID) and Wi-Fi protected access 2 (WPS 2) is competed by pressing exclusive buttons provided at an access point and in a client. In this case, an access point functions as a registrar. A pushbutton system is suitable for a device, in which a client is not provided with a keyboard, as in a game machine and a printer.

In contrast, in a PIN code system, a 4-digit or 8-digit number previously assigned to a client is registered in a registrar from a device already participated in a network. In this case, a client and an access point are connected in a state in which the ESSID and WPA 2 are already set.

Now, IEEE 802.11 communication protocol is explained. ESSID is used as one of network identifiers in wireless LAN. ESSID functions as a so-called network name.

In a network configuration in infrastructure mode, a network including one access point used as a basis and two or more slave wireless LAN terminals is called a basic service set (BSS), and an identifier used therein is called a BSSID. A network including two or more BSS is called ESS, and an identifier used therein is called an ESSID. In this specification, unless otherwise specified, SSID indicates ESSID. SSID is set for preventing connection to an unintended network, or identifying a terminal or device to be connected. In other words, connection between a wireless LAN terminal and an access point is impossible unless the same SSID is set. This function is used to limit users to some degree. An access point periodically delivers packet data called beacon. A beacon packet includes a SSID name of an access point required by a wireless LAN terminal to make connection. A wireless LAN terminal installed in an area able to receive the radio waves can know the presence of an access point and its SSID name by the beacon packet. Therefore, the wireless LAN terminal can set a destination by the beacon SSID, and automatically make connection in the following procedure.

A beacon includes a data part and an application part. A data part includes an element ID, a length of a sending command, an ID, and a format type. An application part includes a device type, a UUID, a service reference URL, a device name, and an IP address. In this embodiment, the automatic wireless communication setting unit 121B of the service execution unit 121 of the digital camera 100 transmits a beacon including information for detecting a device (digital camera) in the application part, from the wireless LAN module 125 through the antenna 130.

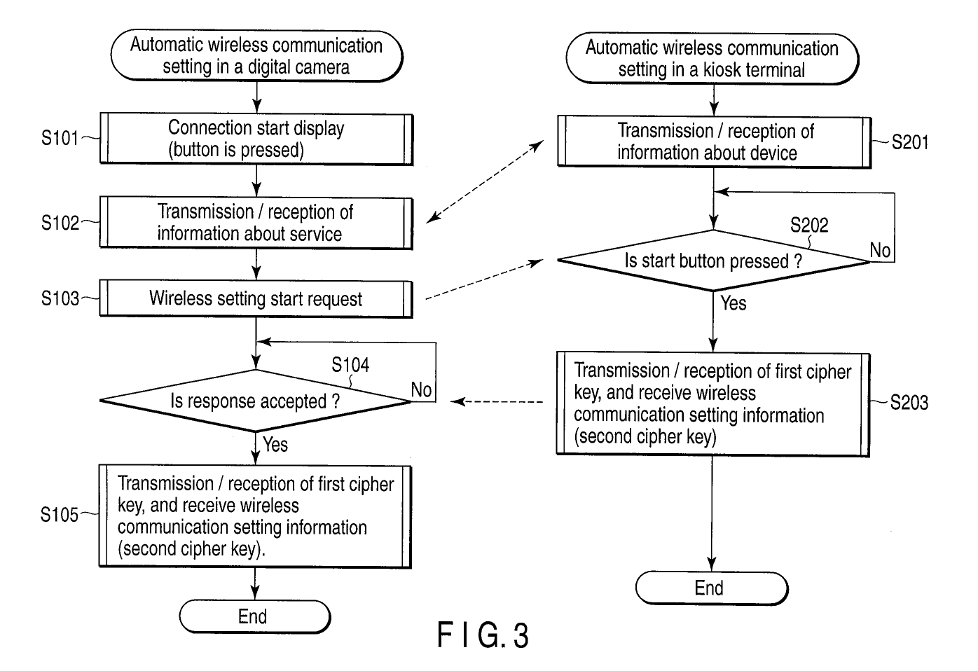

FIG. 3 is a flowchart of automatic wireless communication setting in the service execution unit 121 of the digital camera 100 and the service execution unit 211 of the kiosk terminal 200 in the information processing system. Here, a pushbutton type is used.

When the digital camera 100 capable of making wireless communication goes into an area where communicate with the kiosk terminal 200 connected to the access point 400 is possible, the display LCD 126 of the digital camera 100 indicates this state.

Then, a connection start button (or a virtual button displayed on the display LCD 126) is pressed, and a connection start instruction is given (step S101). The digital camera 100 transmits a beacon including information (SSID) to take part in a network by using the IEEE802.11sequence, to the kiosk terminal 200 (the access point 400) (step S102).

In the kiosk terminal 200, the transmitter-receiver 211A receives the beacon through the access point 400, and returns a response through the access point 400 (step S201).

The digital camera 100 receives the response, and transmits a wireless setting start request, or a wireless connection request (step S103). Then, the digital camera 100 waits for a response from the kiosk terminal 200 (step S104).

The kiosk terminal 200 receives the wireless connection request from the digital camera 100 by the transmitter-receiver 211A, and waits until a start button of the kiosk terminal 200 (or a virtual button displayed on the display LCD 215) is pressed within predetermined time (step S202). When the start button is pressed within predetermined time, the kiosk terminal performs the following operations (step S203). In other words, the transmitter-receiver 211A transmits a cipher key for wireless communication to the digital camera 100 through the access point 400. The transmitter-receiver 211A receives a response from the digital camera 100. The generator 211B generates wireless connection setting information (a cipher key, an encryption method) used for setting wireless communication for ensuring the communication security, as a second cipher key. The storage 211C stores the generated second cipher key. The second cipher key is encrypted by using the first cipher key. The transmitter-receiver 211A transmits the encrypted cipher key to the digital camera 100 through the access point 400.

The digital camera 100 receives the first cipher key (step S104), sends back a response stating the reception of the first cipher key to the kiosk terminal 200, and receives a second cipher key to be sent later from the kiosk terminal (step S105). The digital camera decrypts the second cipher key by the first cipher key received first, and stores the obtained wireless connection setting information (the cipher key, the encryption method) in the storage 121A provided in an area of a memory that the user cannot see.

As described above, when the connection start buttons of the digital camera 100 and kiosk terminal 200 (or the access point 400) are pressed within predetermined time, information is exchanged by radio waves, and the wireless connection setting information for making wireless communication is encrypted and transferred from the kiosk terminal 200 to the digital camera 100.

If a PIN code system is used instead of a pushbutton system, the procedure is as follows. When a PIN code is input to the kiosk terminal 200, a first cipher key is changed to meet a destination selected by a PIN code, and wireless connection setting information for making wireless communication (a second cipher key) is encrypted by a first cipher key, and transferred from the kiosk terminal 200 to the digital camera 100. A PIN code can be input by using a graphics user interface including the display LCD 215 and the operating part 212, by infrared rays, or by reading a bar code.

After the automatic wireless communication setting is completed, a start step and a communication step are sequentially executed, and an application such as viewing photos recorded in the digital camera 100 is executed. In a start step, the digital camera 100 starts communication with the kiosk terminal 200 through a wireless LAN network. This is a part of a communication process by hypertext transfer protocol (HTTP), for example. In a communication step, the digital camera 100 makes communication with the kiosk terminal 200 through a wireless LAN network. The start and communication steps can be executed at any time after the automatic wireless communication setting is completed.

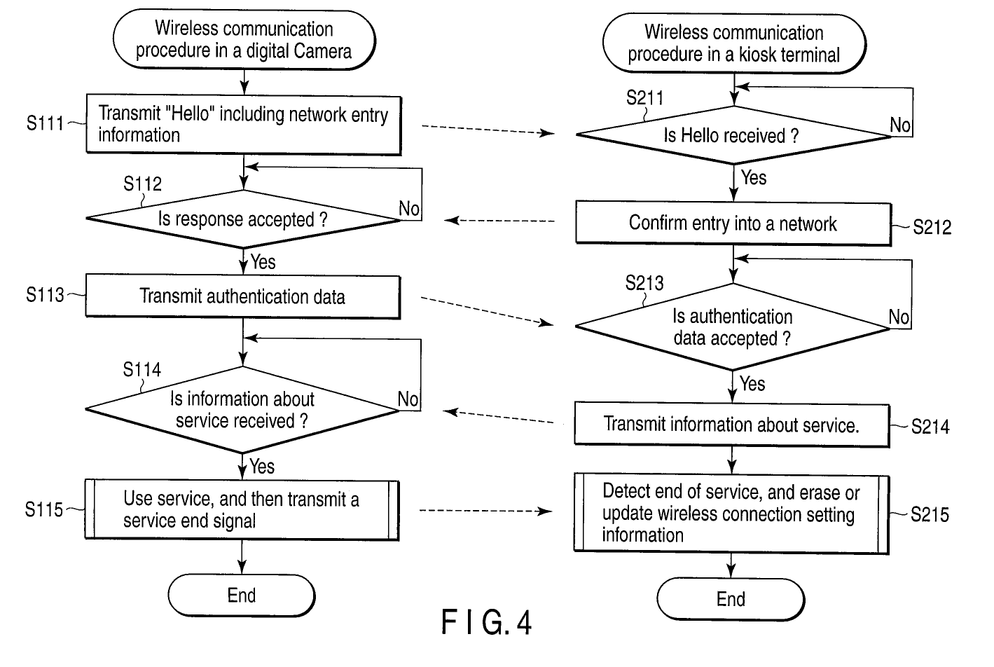

FIG. 4 is a flowchart of wireless communication procedure including a start step and a communication step.

In a start step, the digital camera 100 sends the kiosk terminal 200 network entry information for starting entry into a network (step S111).

The connector 211D of the service execution unit 211 of the kiosk terminal 200 receives the network entry information (step S211), confirms the entry into a network, and sends an entry permission signal to the digital camera 100 (step S212).

The digital camera 100 receives the entry permission (step S112), and performs the following operations (step S113). In other words, the digital camera 100 encrypts the address of the digital camera 100 by using the wireless connection setting information (the second cipher key) stored in the wireless connection information storage 121A, and sends the encrypted address to the kiosk terminal 200. The kiosk terminal 200 receives the address by the connector 211D, decrypts it by using the wireless connection setting information (the second cipher key) stored in the storage 211C, solves the address, and sends an authentication data request to the digital camera 100. The digital camera 100 receives the authentication data request, encrypts authentication data by using the wireless connection setting information (the second cipher key) stored in the wireless connection information storage 121A, and sends the encrypted data to the kiosk terminal 200.

The kiosk terminal 200 receives the authentication data (step S213) by the connector 211D, decrypts the data by using the wireless connection setting information (the second cipher key) stored in the storage 211C, authenticates the data, and when the data is authenticated, sends information about service to the digital camera 100 (step S214).

The digital camera 100 receives the information about service (step S114), identifies the contents (not shown in the drawing), and instructs the kiosk terminal 200 to start an existing universal PnP (UPnP) procedure. According to the instruction, the kiosk terminal 200 executes a communication step based on the UPnP specifications (not shown in the drawing). In other words, the digital camera 100 executes transmission of data, and the kiosk terminal 200 executes reception of the data. The data transmission and reception are performed according to the wireless connection setting information stored in the wireless connection information storage 121A and storage 211C.

One of usable service is printing a photographic image stored in the storage medium 140 of the digital camera 100. In this case, the service execution unit 211 of the kiosk terminal 200 issues a transfer request to the digital camera 100. A photographic image file stored in the storage medium 140 includes file information (update time, creation time, access time, file name, etc.). A header of image file includes attribute information (image size, image acquisition information, thumbnail image, etc.). The transfer request requests the digital camera to sequentially transfer information about an image file conforming to predetermined conditions (file information and attribute information) out of the photographic image files stored in the storage medium 140, and thumbnail image data included in the header of the image file. The digital camera 100 receives the transfer request, and sends the kiosk terminal 200 the data conforming to the predetermined conditions. The kiosk terminal 200 receives the data.

Then, the user finds photographic image data desired to print or store in the management server 300 out of the thumbnail image sent to the kiosk terminal 200, and operates the kiosk terminal 200 to transfer the image data from the digital camera 100 to the kiosk terminal 200. The user confirms the transferred image data, and stores it in the management server 300, or prints the data by the printer 220 or photoprint service provided by the management server 300.

When an instruction to terminate use of the above service, the digital camera 100 terminates use of service, and sends a service end signal to the kiosk terminal 200 (step S115).

The kiosk terminal 200 receives the service end, and performs the following operations (step S215). The detector 211E of the service execution unit 211 determines whether a state of connection to the digital camera 100 conforms to predetermined conditions described later. When the state of communication conforms to the predetermined conditions, the update unit 211F nullifies, erases, or updates a part of all of the wireless connection setting information stored in the storage 211C.

The predetermined conditions include the followings.

(1) Wireless connection lasts for longer than predetermined time.

The detector 211E detects that time of connection to the digital camera 100, time of connection between the digital camera 100 and other terminals connected to the kiosk terminal 200, time of connection between the digital camera 100 and service provided by the kiosk terminal 200, or time of using the service by the digital camera exceeds corresponding predetermined time.

When any one of the above time exceeds the corresponding predetermined time, the update unit 211F nullifies, erases, or updates a part or all of the connection setting information stored in the storage 211C.

(2) Wireless connection is stopped for longer than predetermined time.

The detector 211E determines whether connection to the digital camera 100, connection between the digital camera 100 and other terminals connected to the kiosk terminal 200, connection between the digital camera 100 and service provided by the kiosk terminal 200, or use of the service by the digital camera 100 is stopped for longer than predetermined time. When any one of the above connections is stopped for longer than the predetermined time, the update unit 211F nullifies, erases, or updates a part or all of the connection setting information stored in the storage 211C.

(3) Wireless connection is made by more than a predetermined number of times.

The detector 211E determines whether the number of connections to the digital camera 100, the number of connections between the digital camera 100 and other terminals connected to the kiosk terminal 200, the number of connections between the digital camera 100 and service provided by the kiosk terminal 200, or the number of using the service by the digital camera 100 exceeds a corresponding predetermined number. When any one of the above connections exceeds the corresponding predetermined number, the update unit 211F nullifies, erases, or updates a part or all of the connection setting information stored in the storage 211C.

(4) In the wireless communication, the digital camera 100 detects service provided by the kiosk terminal 200 by multi-casting, and connects the service, and the kiosk terminal 200 transmits and receives predetermined data related to the service.

The detector 211E determines whether the predetermined data is transmitted and/or received between the digital camera 100 and the service provided by the kiosk terminal 200. If the predetermined data is transmitted and/or received, the update unit 211F nullifies, erases, or updates a part or all of the connection setting information stored in the storage 211C.

The predetermined data includes service end data, that is, data indicating the end of service.

(5) In the wireless communication, the digital camera 100 detects service provided by the predetermined kiosk terminal 200 by multi-casting, and connects the service, and the kiosk terminal 200 transmits and receives information related to the service to/from the digital camera 100 for longer than predetermined time and/or by more than a predetermined number of times.

The detector 211E determines whether data is transmitted and/or received to/from the service provided by the kiosk terminal 200 for longer than predetermined time and/or by more than a predetermined number of times. If the data is transmitted or received for longer than predetermined time and/or by more than a predetermined number of times, the update unit 211F nullifies, erases, or updates a part or all of the connection setting information stored in the storage 211C.

This is applied to a case where the digital camera 100 downloads image data, music data, video data, game data, or text data delivered from the kiosk terminal 200 for longer than predetermined time and/or by more than a predetermined number of times.

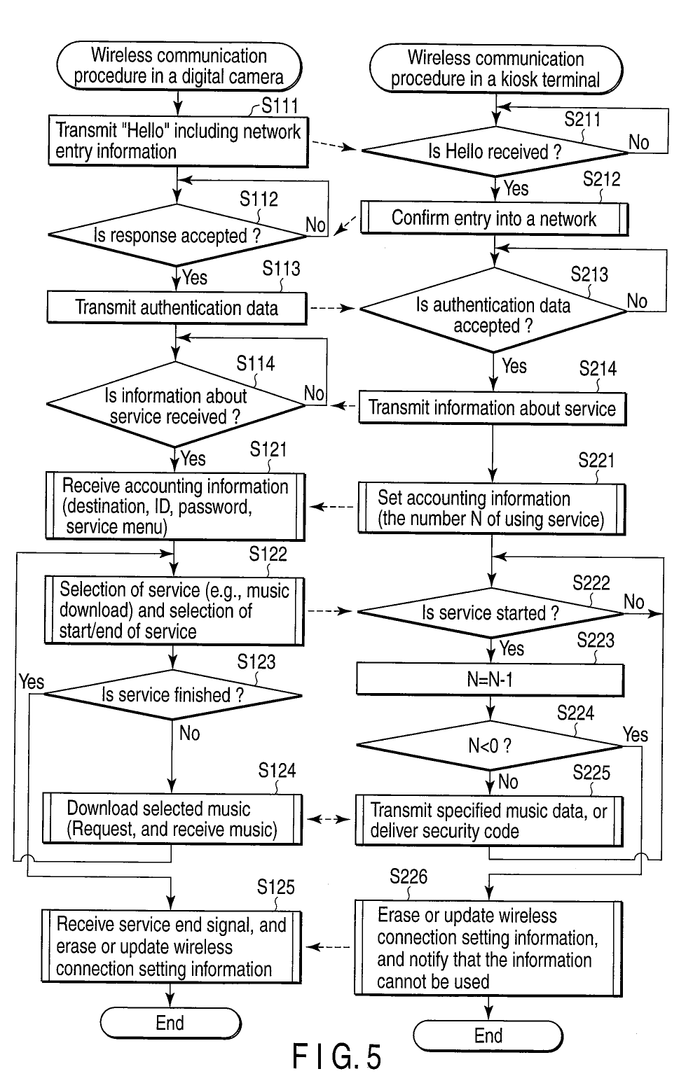

FIG. 5 is a flowchart of wireless communication in the above condition (5), in which music is downloaded by more than a predetermined number of times. In the drawing, steps S111 to S114 in the digital camera 100 and steps S211 to 5214 in the kiosk terminal 200 are the same as those described above, and an explanation thereof is omitted.

In the kiosk terminal 200, accounting information that is the number N of using service, or a predetermined number of times, is input by using a graphics user interface by the display LCD 215 and operating part 212, for example (step S221). The accounting information is transmitted to the digital camera 100. The accounting information includes a destination, an ID, a password, a service menu, etc. as the information related to the service provided by the kiosk terminal 200, in addition to the above predetermined number of times.

The digital camera 100 receives the accounting information (S121), selects start/end of service such as music download (step S122), and sends a service start/end to the kiosk terminal 200. If end of service is not selected (step S123), the digital camera requests the kiosk terminal 200 to download the selected music, and receives the selected music (step S124).

In other words, the kiosk terminal 200 receives a service start (step S222), subtracts one from the number N of using the service (step S223), and determines whether the number N of using the service is decreased to smaller than zero as a result (step S224).

If the number N is not smaller than zero, the kiosk terminal sends specified music data to the digital camera 100 (step S225). Music data itself can be separately downloaded to the digital camera 100 through a personal computer. It is permitted to delivery a security code to enable listening to the downloaded music.

As described above, the service can be used by the number N set in step S221.

When the service is used by the number N, the number N of using the service is determined smaller than zero in step 5224. In this case, the detector 211E of the kiosk terminal 200 detects the above condition (5). Therefore, the update unit 211F nullifies, erases, or updates a part or all of the wireless connection setting information stored in the storage 211C, and sends the digital camera 100 a service end indicating that the wireless connection setting information cannot be used (step S226).

The digital camera 100 receives the service end, and nullifies, erases, or updates a part or all of the wireless connection setting information stored in the wires connection information storage 121A (step S125).

If end of service is selected in step 5122 before the service is used by the number N, a service end signal is sent to the kiosk terminal 200. In this case, though not shown in the drawing, the detector 211E of the kiosk terminal 200 detects the condition (4). Therefore, the update unit 211F can nullify, erase, or update a part or all of the wireless connection setting information stored in the storage 211C. End of service is determined in step S123, and a part or all of the wireless connection setting information stored in the wireless connection information storage 121A is nullified, erased, or updated in step 5115.

The above predetermined conditions further include the following conditions.

(6) In the wireless communication, the digital camera 100 detects service provided by the predetermined kiosk terminal 200 by multi-casting, connects the service, and transmits and receives data related to the service to/from terminals other than the kiosk terminal 200.

The detector 211E detects whether the data related to the service provided by the kiosk terminal 200 is transmitted and/or received between the digital camera 100 and terminals different from the kiosk terminal 200. If the data is transmitted and/or received between the digital camera 100 and the different terminals, the update unit 211F nullifies, erases, or updates a part of all of the connection setting information stored in the storage 211C.

The different terminals include another digital camera, and a management server 300.

(7) Service different from the service provided by other terminals connected first is connected by more than a predetermined number of times, or longer than predetermined time.

The detection unit 211E determines whether a second service different from a first service is connected and/or used for longer than predetermined time and/or by more than a predetermined number of times, after a first service provided by other terminals connected to the kiosk terminal 200 is connected. If the second service is connected and/or used for longer than predetermined time and/or by more than a predetermined number of times, the update unit 211F nullifies, erases, or updates a part of all of the connection setting information stored in the storage 211C.

(8) A disconnection request is received from service provided by connected other terminals.

The detection unit 211E determines whether a disconnection request is received from the service provided by other terminals connected to the kiosk terminal 200. If the disconnection request is received, the update unit 211F nullifies, erases, or updates a part of all of the connection setting information stored in the storage 211C.

This is applied to a case where a mail magazine is subscribed after subscription is stopped, or membership service is joined after withdrawal from the membership. In such a case, a disconnection request is received from a corresponding service.

If end of service is selected before using service by the number N in step S122, the following operation is permitted. The update unit 211F generates wireless connection setting information for verifying reconnection from the SSID and cipher key and encryption method, or the information about the digital camera 100, or the connection date and time (each code is compiled into one code, or converted by comparing with table data). The generated wireless connection setting information for verifying reconnection is stored in the storage 211C, sent to the digital camera 100, and stored in the wireless connection information storage 121A of the digital camera 100. Therefore, the digital camera 100 can receive service by the residual number of times.

In updating the connection setting information in step S125, in which the service is used by the number N, the information that has been set immediately before the wireless connection setting information set by the automatic wireless communication setting, that is, the information one before the current wireless connection setting information is restored. This facilitates returning to the setting usually used at home or office.

It is preferable to store at least a part of the current wireless connection setting information in the history memory 211G, before the update unit 211F nullifies, erases and/or updates the wireless connection setting information. For example, when wireless communication is stopped, the history is recorded in the history memory 211G. Alternatively, the information and history of connection (including date and time) of the connected digital camera 100 may be stored. When the history is stored in the history memory 211G, the history may be displayed on the display LCD 215. Of course, the history stored in the history memory 211G may be kept ready for displaying in the display LCD 215 at any time for confirmation in predetermined security check by a password, for example.

When the update unit 211F updates a part or all of the connection setting information, the wireless connection setting information may be updated based the history stored in the history memory 211G.

As described above, according the embodiment of the invention, even if indefinite number of digital camera 100 make wireless communication with the kiosk terminal 200, a part or all of the wireless connection setting information is nullified, erased or updated when predetermined conditions are satisfied. Therefore, the same wireless connection setting information as those of other users is not used, and the security of wireless connection setting information is ensured.

The generator 211B may be provided at the access point 400, not in the kiosk terminal 200.

A digital camera is used as an external terminal in the embodiment described hereinbefore. Any mobile information communication terminal such as a cell-phone and PDA may be used. Similarly, a kiosk terminal is used as an information communication terminal. Other terminals such as a personal computer may be used.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

What is claimed is:

1. An information communication terminal for making communication with a predetermined external terminal through wireless connection, comprising:
a receiver configured to receive a wireless connection request from the predetermined external terminal;
a wireless connection information generator configured to generate wireless connection setting information, based on the wireless connection request;
a storage configured to store the wireless connection setting information generated by the wireless connection information generator;
a transmitter configured to transmit the wireless connection setting information generated by the wireless connection information generator, to the predetermined external terminal;
a connector configured to make wireless connection to the predetermined external terminal, based on the wireless connection setting information;
a detector configured to determine whether a communication state of the predetermined external terminal confirms to one of predetermined conditions; and
a wireless connection setting information update unit configured to perform one of nullification, erasion and update of one of a part and all of the wireless connection setting information stored in the storage, when a communication state of the predetermined external terminal conforms to one of the predetermined conditions.

2. The terminal according to claim 1, wherein
the connector is configured to make wireless connection to the predetermined external terminal through a wireless access point connected to the information communication terminal.

3. The terminal according to claim 1, further comprising:
a history memory configured to store at least a part of current wireless connection setting information, before the wireless connection setting information update unit performs the one of nullification, erasion and update of the wireless connection setting information.

4. The terminal according to claim 3, wherein
the wireless connection setting information update unit is configured to update the wireless connection setting information based on the wireless connection setting information stored in the history memory, when updating the one of the part and the all of the wireless connection setting information.

5. The terminal according to claim 1, wherein
the detector is configured to detect that one of time of connection to the predetermined terminal, time of connection between the external terminal and other terminal connected to the information communication terminal and, time of connection between the external terminal and service provided by the information communication terminal, and time of using the service by the external terminal exceeds corresponding predetermined time, and
the wireless connection setting information update unit is configured to perform the one of nullification, erasion and update of the one of the part and the all of the wireless connection setting information stored in the storage, when the one of the time of connection to the predetermined external terminal, the time of connection between the external terminal and the other terminal, the time of connection between the external terminal and the service, and the time of using the service by the external terminal exceeds the corresponding predetermined time.

6. The terminal according to claim 1, wherein
the detector is configured to detect that one of connection to the predetermined external terminal, connection between the external terminal and the other terminal, connection between the external terminal and the service, and use of the service by the external terminal is stopped for longer than corresponding predetermined time, and
the wireless connection setting information update unit is configured to perform the one of nullification, erasion and update of the one of the part and the all of the wireless connection setting information stored in the storage, when the one of the connection to the predetermined external terminal, the connection between the external terminal and the other terminal, the connection between the external terminal and the service, and the use of the service by the external terminal is stopped for longer than the corresponding predetermined time.

7. The terminal according to claim 1, wherein
the detector is configured to detect that one of the number of connections to the predetermined terminal, the number of connections between the external terminal and the other terminal, the number of connections between the external terminal and the service, and the number of using the service by the external terminal exceeds a corresponding predetermined number, and
the wireless connection setting information update unit is configured to perform the one of nullification, erasion and update of the one of the part and the all of the wireless connection setting information stored in the storage, when the one of the number of connections to the predetermined communication terminal, the number of connections between the external terminal and the other terminal, the number of connections between the external terminal and the service, and the number of using the service by the external terminal exceeds the corresponding predetermined number.

8. The terminal according to claim 1, wherein
the detector is configured to determine whether one of a transmission and a reception of predetermined data between the external terminal and the service is performed, and
the wireless connection setting information update unit is configured to perform the one of nullification, erasion and update of the one of the part and the all of the wireless connection setting information stored in the storage, when the one of the transmission and reception of the predetermined data between the external terminal and the service is performed.

9. The terminal according to claim 1, wherein
the detector is configured to determine whether one of a transmission and a reception of data between the external terminal and the service is performed one of for longer than predetermined time and by more than a predetermined number of times, and
the wireless connection setting information update unit is configured to perform the one of nullification, erasion and update of the one of the part and the all of the wireless connection setting information stored in the storage, when the one of the transmission and the reception of data between the external terminal and the service is performed the one of for longer than predetermined time and by more than a predetermined number of times.

10. The terminal according to claim 1, wherein
the detector is configured to determine whether one of a transmission and a reception of data related to the service between the external terminal and a terminal different from the information communication terminal is performed, and
the wireless connection setting information update unit is configured to perform the one of nullification, erasion and update of the one of the part and the all of the wireless connection setting information stored in the storage, when the one of the transmission and the reception of data related to the service between the external terminal and the terminal different from the information communication terminal is performed.

11. The terminal according to claim 1, wherein
the detector is configured to determine whether one of a connection to and a use of a second service different from a first service is performed one of by more than a predetermined number of times and for longer than predetermined time, after the first service provided by other terminal connected to the information communication terminal is connected, and
the wireless connection setting information update unit is configured to perform the one of nullification, erasion and update of the one of the part and the all of the wireless connection setting information stored in the storage, when the one of the connection to and the use of the second service different from the first service is performed by more than a predetermined number of times and for longer than predetermined time, after the first service provided by other terminal connected to the information communication terminal is connected.
